(19) United States
(12) Patent Application Publication
(10) Pub. No.: US 2009/0295786 A1
(43) Pub. Date: Dec. 3, 2009

(54) DRIVING CIRCUIT FOR A LIQUID CRYSTAL DISPLAY

(75) Inventors: Daisuke ITO, Minato-ku (JP); Yoshitoshi KIDA, Minato-ku (JP); Takeya TAKEUCHI, Minato-ku (JP); David PUSEY, Basingstoke (GB); Peter SHADWELL, Tadley (GB); Shunsuke NOICHI, Minato-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/473,022

(22) Filed: May 27, 2009

(30) Foreign Application Priority Data
May 27, 2008 (GB) 0809584.6

(51) Int. Cl. G09G 3/36; G06F 3/038

(52) U.S. Cl. 345/215; 345/90

(57) ABSTRACT

A driving circuit for a liquid crystal display module having an array of liquid crystal cells and signal lines, each liquid crystal cell being chargeable via one of the signal lines by any amount between two saturated values so as to provide a corresponding display intensity. The driving circuit is configured to charge selectively all the liquid crystal cells of the array during a frame period so as to cause the array of liquid crystal cells to display an image. During a normal mode of operation, all of the liquid crystal cells are recharged repeatedly at a first refreshed rate. During a low power mode of operation, all of the liquid crystal cells are recharged repeatedly at a second refresh rate, lower than said first refreshed rate. Also, during the low power mode of operation, all of the liquid crystal cells are charged only to one or other of the two saturated values.

### BACKGROUND OF THE INVENTION

1. Field of the Invention

The present invention relates to a driving circuit and method of driving a liquid crystal display and, in particular, to selectively driving the display in a low-power mode of operation where the display is not in normal use.

2. Description of the Related Art

Liquid crystal displays are well known using a two-dimensional array of liquid crystal cells in which the cells share a plurality of signal lines in one direction and are selectively enabled by gate lines in a perpendicular direction. Drive circuits are provided which use the gate lines to enable respective sets of liquid crystal cells. The signal lines are then used to provide video signal levels to the enabled cells to charge those cells to the level required to give those cells their desired brightness.

It is usual to group the liquid crystal cells together to form image pixels. Each image pixel would typically include three liquid crystal cells corresponding respectively to red, green and blue. The red, green and blue liquid crystal cells of a pixel are provided on the same gate line and, indeed, can be driven by the same video signal. In particular, with a gate line enabling all of the liquid crystal cells of the pixel, the video signal is provided first to the red liquid crystal cell by means of its signal line, then to the green liquid crystal cell by means of its signal line and finally to the blue liquid crystal cell by means of its signal line.

Low-power modes of operation are well known for liquid crystal display modules.

Where the liquid crystal display module is provided in a device such as a mobile telephone or camera, if that device is not used for a predetermined period of time, then the driving circuit switches from a normal mode of operational to a low-power mode of operation.

### OBJECTS AND SUMMARY OF THE INVENTION

Typically, liquid crystal display modules are provided with back lights. Individual liquid crystal display cells in the liquid crystal display have a transitivity which is varied by signal lines according to the image to be displayed and the back light illuminates these liquid crystal display cells from behind. If the device is not being used, the back light can be turned off so that the image becomes visible only faintly by virtue of reflected incident light. This arrangement can provide effect power saving. However, the present application recognises that it will be desirable to achieve further power savings.

According to the present invention, there is provided a method of driving a liquid crystal display having an array of liquid crystal cells and signal lines, each liquid crystal cell being chargeable via one of the signal lines by any amount between two saturated values so as to provide a corresponding display intensity. The method includes charging selectively all of the liquid crystal display cells of the array during a frame period so as to cause the array of liquid crystal cells to display an image. During a normal mode of operation, all of the liquid crystal cells are recharged repeatedly at a first refresh rate. During a low-power mode of operation, all of the liquid crystal cells are recharged repeatedly at a second refresh rate, lower than said first refresh rate.

According to the present invention, there is also provided a driving circuit for a liquid crystal display module having an array of liquid crystal cells and signal lines, each liquid crystal cell being chargeable via one of the signal lines by any amount between two saturated values so as to provide a corresponding display intensity. The driving circuit is configured to charge selectively all of the liquid crystal cells of the array during a frame period so as to cause the array of liquid crystal cells to display an image. During a normal mode of operation, all of the liquid crystal cells are recharged repeatedly at a first refresh rate. During a low-power mode of operation, all of the liquid crystal cells are recharged repeatedly at a second refresh rate, lower than said first refresh rate.

According to the present invention, there is also provided a driving circuit for a liquid crystal display module having a frame formed of an array of liquid crystal cells and signal lines, each liquid crystal cell being chargeable via one of the signal lines by any amount between two saturated values so as to provide a corresponding display intensity. The driving circuit is configured to charge selectively all of the liquid crystal cells of the frame within a frame period having a normal refresh rate so as to cause the array of liquid crystal cells to display an image. During a first mode of operation, the circuit cycles through at least one frame period before again charging selectively all of the liquid crystal cells of the array such that, during the first mode of operation, the driving circuit is configured to recharge all of the liquid crystal cells of the array repeatedly at a low refresh rate lower than said normal refresh rate for charging an individual frame of the array of liquid crystal cells.

According to the present invention, there is also provided a method of driving a liquid crystal display having a frame formed of an array of liquid crystal cells and signal lines, each liquid crystal cell being chargeable via one of the signal lines by any amount between two saturated values so as to provide a corresponding display intensity. The method includes charging selectively all of the liquid crystal cells of the frame within a frame period having a normal refresh rate so as to cause the array of liquid crystal cells to display an image. The method further includes, during a first mode of operation, cycling through at least one frame period before again charging selectively all of the liquid crystal cells such that, during the first mode of operation, recharging successive frames occurs at a low refresh rate lower than said normal refresh rate for charging an individual frame of the array of liquid crystal cells.

As is well know, each time an image frame of a liquid crystal display is refreshed, the liquid crystal display cells must be recharged. Also, other components, such as the COM plate to which the liquid crystal display cells are attached must be recharged. Various components, such as the COM plate have capacitance and power is consumed when charge is provided to these capacitive features. The situation is made worse by the fact that liquid crystal display cells require inversion between consecutive refresh cycles such that the polarity on the various capacitive features must be reversed.

In the low-power mode, it is assumed that a viewer will be more tolerant of imperfections in the displayed image.

The first refresh rate is set at any known conventional refresh rate for providing an image of desirably quality. With the present invention, it is recognised that, at other times, the refresh rate can be lowered so as to save power.

In this respect, it is expected that a typical power consumption of 3 mW could be reduced to 1 mW.

Preferably, the first refresh rate is any known standard refresh rate for providing a normal image of acceptable quality, for instance between 50 and 60 times per second.

In essence, the second refresh rate can be any lower refresh rate which is still acceptable for the particular application of the liquid crystal display. In this respect, refresh rates between 10 and 1 times per second are possible. Preferably the second refresh rate is 10 times per second or lower or even 5 times per second or lower.

Preferably, the driving circuit includes a clock circuit configured to generate a synchronous pulse, the driving circuit being responsive to the synchronous pulse to recharge all of the liquid crystal cells.

The clock circuit can be configured to generate the synchronous pulse at the first refresh rate. In other words, the synchronous pulse corresponds to a vertical synchronous pulse for use at the start of each field/frame of an image.

The second refresh rate can be achieved in a number of different ways.

In one aspect, during the low-power mode of operation, the driving circuit is configured to ignore a predetermined plurality of consecutive synchronous pulses so as to recharge all of the liquid crystal cells at the second refresh rate. At the same time, the driving circuit may ignore received frames of image data and refresh the liquid crystal display only with received frames corresponding to the synchronous pulses acted upon according to the second refresh rate.

Alternatively, the clock circuit could be configured to, during the low-power mode of operation, generate the synchronous pulse at the second refresh rate. Once again, the driving circuit could be configured to ignore received frames of image data which are received between the synchronous pulses at the second refresh rate.

Preferably, during the low-power mode of operation, the driving circuit is configured to charge all of the liquid crystal cells only to one or other of the two saturated values.

Thus, for a black and white display, no grey tones will be displayed and the image will be displayed only in black and white pixels. On the other hand, for a colour display, all sub-pixels/pixel units will be driven to full transmissivity or zero transmissivity such that the display operates in an 8-colour mode.

When an individual liquid crystal display cell is driven with a potential so as not to be saturated and so as to provide an intermediate transmissivity, as soon as the signal has been applied, leakage current will cause the potential on the liquid crystal cell to change and fading of the image to occur. Even though the liquid crystal display is being operated in a low-power mode where a user is less concerned regarding image quality, fading of the image between consecutive refreshing of the image may still be undesirable.

In the saturated state of the liquid crystal display cell, some leakage current and some drop in potential can occur before any change in transmissivity occurs. Hence, by only using liquid crystal display cells in their saturated state during the low-power mode, longer refresh periods can be used without noticeable flicker.

Preferably, during the low-power mode of operation, between charging respective liquid crystal cells, the driving circuit is configured to maintain on each signal line a voltage optimum to reduce charge leakage from the respective liquid crystal cells.

After a liquid crystal display cell has been charged to its desired value and the corresponding signal line is disconnected by means of a respective switch, there is still a possibility of leakage current across the switch to the signal line. It is now recognised that actively driving the signal line to a particular potential can reduce the potential difference across the switch and hence reduce the leakage current. In this way, the extended refresh periods can be achieved.

Preferably, during the low-power mode of operation, between charging respective liquid crystal cells, the driving circuit is configured to maintain on each signal line a voltage of zero volts relative to the ground side of the liquid crystal cells.

Considering the transmissivity properties of a liquid crystal cell, it is noted that a liquid crystal cell is more sensitive to changes in transmissivity at low potential differences across the liquid crystal cell than at high potential differences across the liquid crystal cell. Therefore, refresh rates can be reduced further if the signal lines are kept close to the zero or ground voltage of the liquid crystal cells between signal writing. In some inversion methods, the COM line to which the ground side of the liquid crystal cells are connected steps up and down. In these arrangements, it is preferable that the voltage on the signal lines, between charging respective liquid crystal cells, follows the COM voltage.

Preferably, the driving circuit is used with a liquid crystal display module having a selectively operable back light. When in the low-power mode of operation, the driving circuit is preferably configured to turn off the back light.

Because the resulting image is more dim when the back light is turned off, using saturated values of the liquid crystal display cells is less apparent to a viewer. Hence, longer refresh times can be achieved without disturbing the viewer. The driving circuit may be embodied in a liquid crystal display module including a liquid crystal display.

Also, the module may be provided in any appropriate device, such as a mobile telephone or camera.

### BRIEF DESCRIPTION OF THE DRAWINGS

FIG. 1 illustrates a mobile telephone in which the present invention may be embodied;

FIG. 2 illustrates a camera in which the present invention may be embodied;

FIG. 3 illustrates a liquid crystal display module in which the present invention may be embodied;

FIG. 4 illustrates schematically three pixel units of a pixel of a liquid crystal display;

FIG. 5 illustrates the timing of signals for driving the pixel units of FIG. 4;

FIG. 6 illustrates the transmission response of a typical liquid crystal display cell;

FIG. 7 illustrates the transmission response of another typical liquid crystal display cell; and

FIG. 8 illustrates schematically DC driving of a liquid crystal display cell.

### DETAILED DESCRIPTION OF THE PREFERRED EMBODIMENTS

The invention will be more clearly understood from the following description, given by way of example only, with reference to the accompanying drawings.

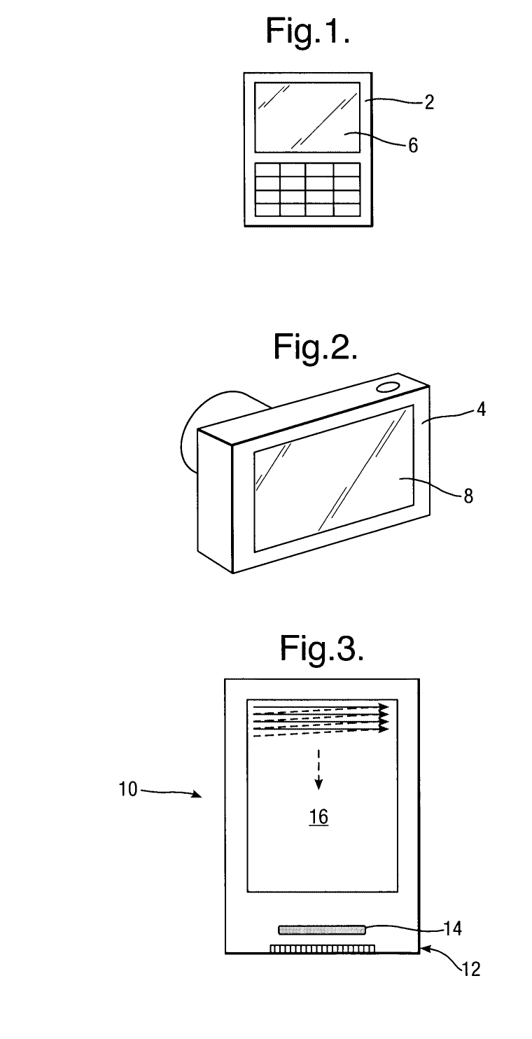

The present invention is applicable to LCD (Liquid Crystal Display) modules such as are used in mobile telephone devices or digital cameras, for instance as illustrated respectively in FIGS. 1 and 2. The present invention could be applied to any LCD, including those with LCD driving circuits formed on the display panel of the LCD module itself.

In the mobile telephone device 2 of FIG. 1 and the digital camera 4 of FIG. 2, respective LCD modules 6 and 8 are provided for displaying images as required.

FIG. 3 illustrates an LCD module 10 which is suitable for use in mobile telephone devices and digital cameras and which embodies the present invention.

The LCD module 10 includes at least one plate 12 made of glass (or any other suitable transparent material) against which a liquid crystal display 16 is formed in any known manner. In the illustrated embodiment, a driving circuit 14 is also formed on the glass plate 12. An LCD driving circuit 14 according to the present invention is illustrated at a lower portion of the display module 10. A similar driving circuit could be provided at any portion of the glass plate 12 around the display area 16 or, indeed, in a distributed manner around the display area 16.

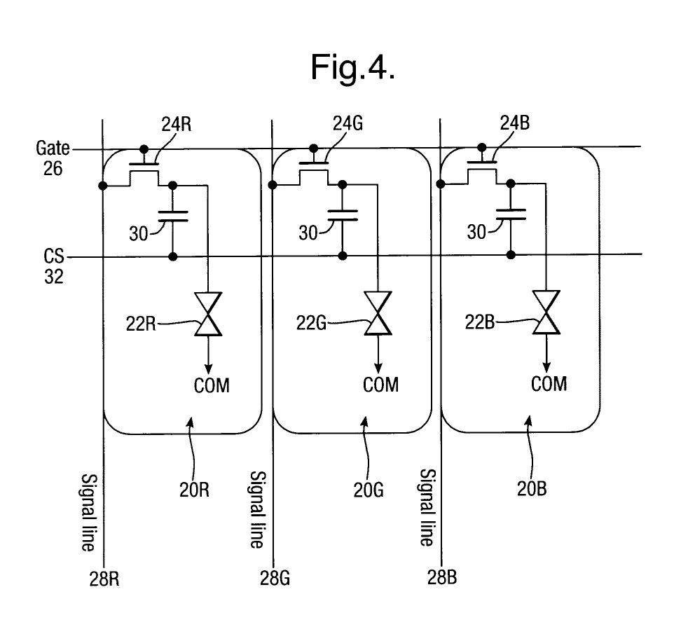

FIG. 4 illustrates one example of how the display area 16 can be implemented.

The display area 16 is divided into a two-dimensional array of pixels. The pixels extend in horizontal rows in a first direction and in vertical columns in a second direction. By activating each pixel with a desired colour and brightness, an appropriate image can be displayed on the display 16.

In order to produce a variety of different colours, each pixel includes three pixel units 20R, 20G, 20B (otherwise known as sub-pixels) respectively for producing red, green and blue. FIG. 4 illustrates the three pixel units 20R, 20G, 20B of a pixel arranged side by side in the first (horizontal) direction. In this respect, it should be appreciated that the three pixel units 20R, 20G, 20B should be located close to one another in order to provide the desired visual combined colour, but the exact positioning of the pixel units is not critical.

Each of the pixel units 20R, 20G, 20B includes a corresponding liquid crystal cell 22R, 22G, 22B. One side of every liquid crystal cell 22R, 22G, 22B is connected to a common line COM which, in the preferred embodiment, is formed as part of the glass plate 12 itself. The opposite side of each liquid crystal cell 22R, 22G, 22B is connected to a respective control transistor or switch 24R, 24G, 24B.

As illustrated, all of the switches 24R, 24G, 24B in a row are controlled, in other words switched on or off, by means of a common gate line 26. A respective gate line is provided for each of the rows of the display 16. On the other hand, the inputs to the switches 24R, 24G, 24B are connected to signal lines 28R, 28G, 28B. In particular, all of the red pixel units 20R in the same column are connected to a single respective signal line 28R, all of the green pixel units 20G in the same column are connected to a single respective signal line 28G and all of the blue pixel units 20B in the same column are connected to a single respective signal line 28B.

In order to display an image on the display area 16 of the LCD module 10, an image is provided row by row. A particular gate line 26 is driven to a voltage so as to turn on all of the switches or transistors 24R, 24G, 24B in its respective row. While that gate line enables that particular row or horizontal line, first all of the red signal lines 28R are used to drive all of the red liquid crystal cells 22R in that row, then all of the green signal lines 28G are used to drive all of the green LCD cells 22G in that particular row and, finally, all of the blue signal lines 28B are used to drive all of the blue liquid crystal cells 22B in that particular row. Preferably, all of the pixel units 20R, 20G, 20B of a particular colour are driven simultaneously. However, other arrangements are also possible.

With one row or horizontal line written, the corresponding gate line 26 is driven to a voltage to turn off all of its corresponding switches or transistors 24R, 24G, 24B and another gate line is driven to a voltage to turn on its corresponding switches. Adjacent gate lines 26 can be driven one after the other, but other arrangements are possible. It will also be appreciated that different arrangements of arrays of pixel units can be provided to achieve the same effect.

In practice, the liquid crystal capacitance is somewhat variable and it becomes difficult, with only the arrangement described above, to drive reliably the liquid crystal cells 22R, 22G, 22B to the appropriate or desired brightness levels. To help compensate for the variability of the liquid crystal cells 22R, 22G, 22B, CS capacitors 30 are provided in parallel with the liquid crystal cells 22R, 22G, 22B. As illustrated, the CS capacitors 30 are provided between the signal driving end of the liquid crystal cells 22R, 22G, 22B and a CS line 32. For the arrangement described above, a CS line 32 is provided for each respective row or horizontal line. Thus, the CS capacitors 30 of all of the pixel units 20R, 20G, 20B of a respective row or horizontal line are connected to a corresponding respective CS line 32.

The CS line 32 is driven with a voltage corresponding closely to the voltage of the common voltage COM. In this way, variations in the capacitance of the liquid crystal cells 22R, 22G, 22B have less effect on driving of those liquid crystal cells 22R, 22G, 22B.

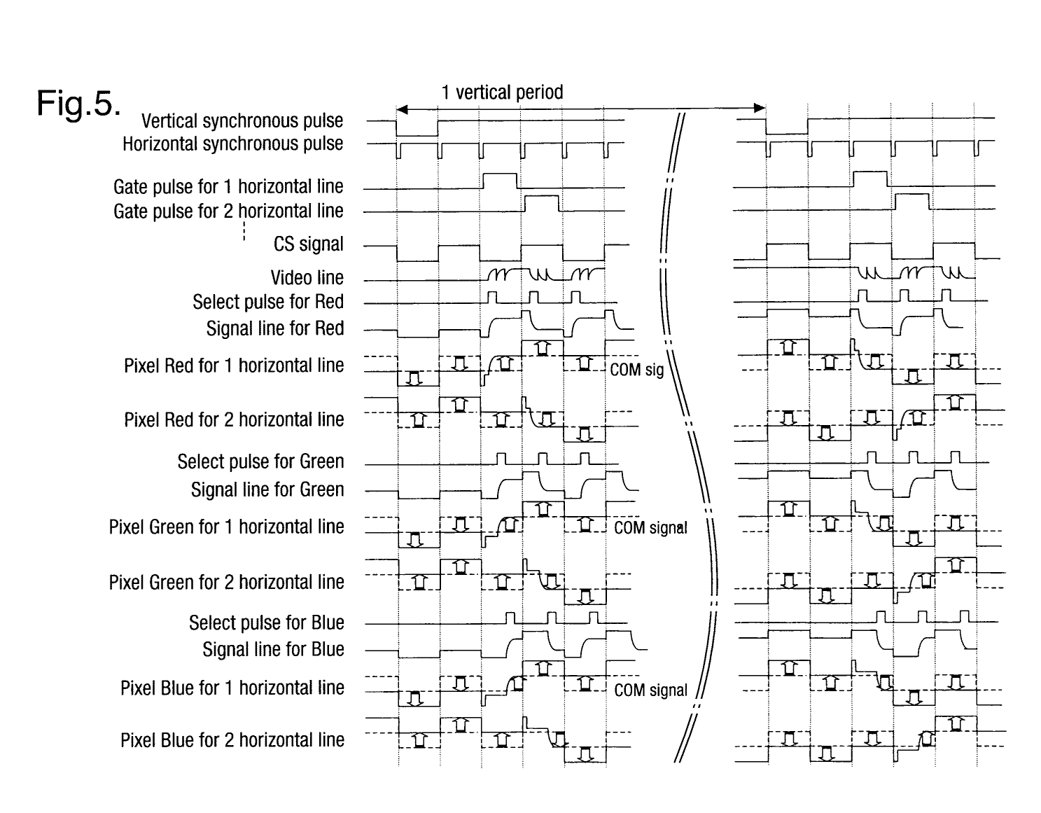

FIG. 5 illustrates various signals for driving the first two horizontal lines of the display 16 according to a 1H inversion method. In this regard, it is worth noting that, for ongoing operation of the liquid crystal display 16, it is necessary to reverse the polarity applied to the liquid crystal cells 22R, 22G, 22B each time they are used; this is known as inversion. Hence, after each frame is displayed on the display 16, in other words after each vertical period, the polarity is reversed. For 1H inversion, also, adjacent horizontal lines are driven with opposite polarities.

As illustrated in FIG. 5, a vertical synchronous pulse having the length of one horizontal timing signifies a new frame. Also, a short horizontal synchronous pulse is provided to indicate each new horizontal line or row.

Gate pulses are shown for the first and second horizontal lines. Each gate pulse lies within the horizontal line period and, during a gate pulse, the respective row or horizontal line of pixel units 20R, 20G, 20B are enabled in the manner described above. Thus, during the gate pulse for the first horizontal line, all of the switches/transistors 24R, 24G, 24B of the first horizontal line are enabled, but none others. Similarly, for the second horizontal gate pulse, only the switches/transistors of the second row or horizontal line are enabled.

In FIG. 5, the voltages for a red pixel unit 20R, a green pixel unit 20G and a blue pixel unit 20B are indicated for first and second horizontal lines. The COM signal is illustrated as a dashed line overlying the voltage illustrated for the liquid crystal cells 22R, 22G, 22B of the pixel units 20R, 20G, 20B. For the illustrated 1H inversion, from one horizontal line to the next, the COM signal changes from one voltage state to another. In this way, the polarity applied to adjacent horizontal rows of pixels is reversed. As also illustrated, for the second vertical period (on the right side of FIG. 5), the COM signal is reversed as a whole such that the pixels of a horizontal line are driven with opposite polarity from frame to frame.

The CS signal follows the COM signal with generally the same voltage.

The COM signal and CS signal change can state between zero volts and approximately 5 volts.

Within each horizontal period, respective select pulses are provided for the red pixel units 20R, green pixel units 20G and blue pixel units 20B. In this way, a common video line can be provided for one pixel, that video line including consecutively the driving signal required for the red pixel unit 20R, green pixel unit 20G and blue pixel unit 20B of the same pixel. The select pulses illustrated in FIG. 5 are used to apply appropriate portions of the video line signal to the respective red, green and blue pixel units 20R, 20G, 20B. As a result, during a particular respective select pulse, the signal line for the respective pixel unit 20R, 20G, 20B is driven to the required voltage provided by the common video line signal at that time.

It is now proposed that a liquid crystal display such as described above should be operable both in a normal mode as described above and also in a low-power mode.

In the low-power mode, it is proposed that the refresh rate be reduced. In other words, the frequency with which a complete frame of pixels or pixel units are rewritten is reduced. It will be appreciated from the above explanation that, whenever pixels or pixel units are rewritten or refreshed, it necessary to invert the potential. Because of the capacitance of the various components, in particular the COM line/plate, this consumes a relatively large amount of power. By reducing the frequency at which rewriting or refreshing occurs, the power consumption can be reduced.

Unfortunately, between the times at which signals are written to the liquid crystal display cells, leakage will occur such that the potential on the liquid crystal display cells diminishes and the displayed image fades. When the liquid crystal display cells are refreshed, of course, they are taken back to their correct potential and the correct image intensity is displayed. This change in image intensity will result in a visible flicker to the viewer.

Visible flicker is generally unacceptable to users and, hence, there is a limit to which the refresh rate can be reduced, even when a liquid crystal display is being used in a low-power or power-save mode.

It is now recognised that, if the liquid crystal display cells are in a saturated state, then some leakage can occur before any appreciable degradation in the image occurs such that the refresh rate can be reduced further. In the case of a black and white display, then the liquid crystal display will be driven such that all pixels are either black or white. On the other hand, in the case of a colour display, all pixel units or sub-pixels will be driven so as to be black or respectively full red, full blue or full green, in other words, an 8-colour display.

When the liquid crystal display is driven in this manner, it becomes possible to operate the liquid crystal display in a low-power mode having a refresh rate lower than the normal refresh rate.

It is proposed that the driving circuit 14 of the liquid crystal display module can either determine that the image is merely black-and-white or 8-colour or, alternatively, the driving circuit, in a low-power mode of operation, converts any received frames of image data into full black-and-white or 8-colour.

In order to provide the lower refresh rate, it is possible for the driving circuit 14 to be provided with a clocking signal for a lower frame rate different to the normal clocking signal for the normal frame rate. However, in the preferred embodiment, the driving circuit 14 uses the same clocking signal for frames, for instance the vertical synchronous pulse illustrated in FIG. 5, but ignores a predetermined consecutive number of frame clocking signals (vertical synchronous pulses) in order to achieve the lower refresh rate.

In many arrangements, the liquid crystal display module will be receiving a consecutive series of image frames for display irrespective of whether it is operating in a normal mode or a low-power mode. In the low-power mode with the low refresh rate, the driving circuit 14 is configured to ignore frames of image data received at the time of clocking signals (vertical synchronous pulses) which are ignored.

After the process of connecting a signal line 28 to a liquid crystal display cell 22 via its switch 24 and then turning off the switch 24 so as to disconnect the signal line 28, conventionally, little consideration has been given to the voltage on the signal line 28. However, inevitably, some leakage will occur from a liquid crystal display cell 22 through its switch 24 to its signal line 28. If the potential difference between the signal line 28 and the liquid crystal display cell 22 is larger, then the leakage current will be greater.

It is now proposed to control the voltage on the signal lines 28, at least during the lower-power mode, so as to reduce the leakage current from the liquid crystal display cells 22 and, hence, allow longer refresh rates.

In a liquid crystal display having individual respective signal lines for individual respective liquid crystal display cells, it would be possible to maintain drive of individual signal lines with the respective potentials corresponding to the potentials on their respective liquid crystal display cells 22. In this way, with no potential difference across the respective switches 24, leakage currents to the signal lines 28 could be eliminated. However, even in an arrangement such as this, it should be noted that the COM line to which all liquid crystal display cells 22 are connected oscillates, as described above with reference to FIG. 5, so as to produce the desired inversion. The potential on the other side of the liquid crystal display cells 22 thus oscillates up and down also such that it would be necessary to oscillates the potential on the respective signal lines 28 accordingly.

As explained above, in most liquid crystal display arrangements, each signal line is actually connectable to a plurality of different liquid crystal display cells 22. In the embodiment described with reference to FIG. 4, gate lines 26 control the switches 24 of liquid crystal display cells 22 across a horizontal line, whereas each signal line 28 is able to provide a signal to an array of liquid crystal display cells 22 arranged in a vertical column. Having used a signal line 28 to write a signal to a liquid crystal display cell 22 of a particular horizontal line, that signal line 28 could be held at its potential while all of the other liquid crystal display cells 22 of that horizontal line are written by other signal lines 28. However, it will be appreciated that, because liquid crystal display cells 22 of other horizontal lines use the same signal line 28, the potential held on the particular signal line 28 might be inappropriate for the potential written to the other liquid crystal display cells 22 in its vertical column.

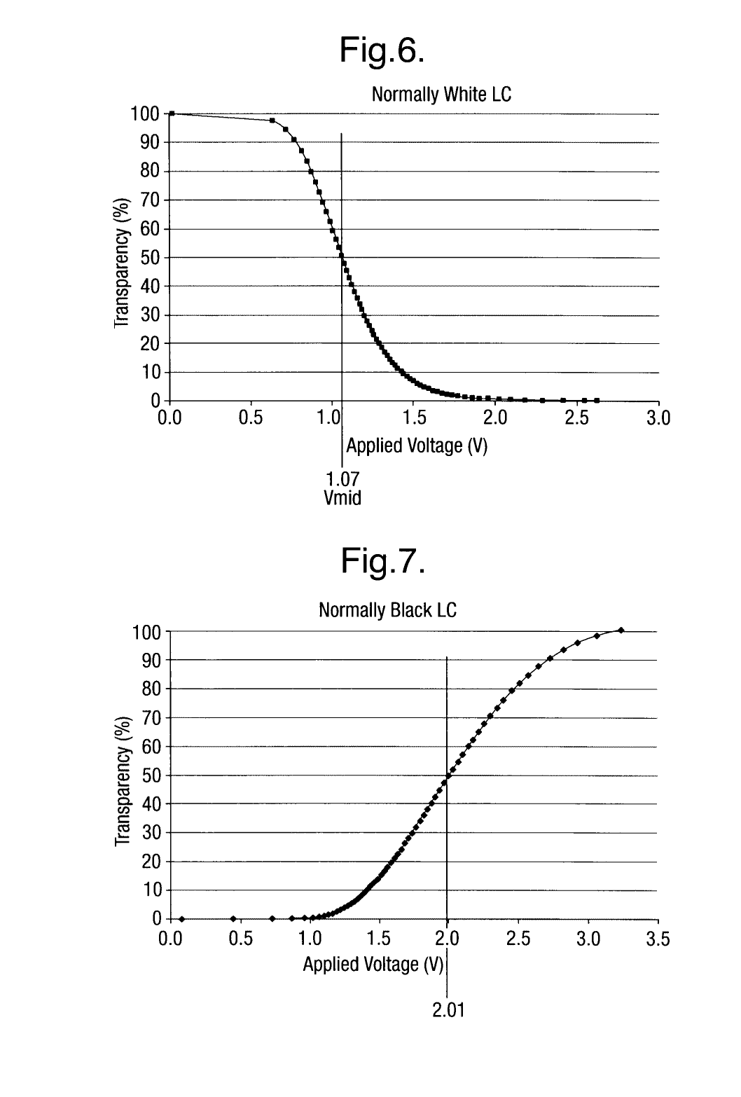

FIG. 6 illustrates a typical response profile for a liquid crystal display cell measuring transmittance as a percentage against the voltage applied across the liquid crystal display cell. It will be appreciated that the response is generally symmetric for positive and negative applied voltages.

Using a liquid crystal display cell having the response as illustrated in FIG. 6 and using it in its saturated states as proposed for the low-power mode, it will be seen that applying 2.7 volts (whether positive or negative) across the liquid crystal display cell will reduce transmittance effectively to zero. On the other hand, with zero volts applied across the liquid crystal display cell, then the liquid crystal display cell provides approximately 100 percent transmittance.

If 2.7 volts is applied to the liquid crystal display cell and a leakage current is present, then the voltage across the liquid crystal display cell will reduce. From the characteristics shown in FIG. 6, it will be appreciated that the voltage can fall by 0.8 volts before the transmittance increases by 1 percent. On the other hand, when the liquid crystal display cell is initially provided with zero volts and a leakage current is present, an increase of only 0.25 volts will result in a reduction of transmittance by approximately 1 percent.

Noting the asymmetry between applying a voltage and non-transmittance on the one hand and not applying a voltage and transmittance on the other hand, it will be appreciated that the zero volts/transmittance side of the response of a liquid crystal display cell is more sensitive to leakage current. This can be taken into account when controlling the driving of the liquid crystal display.

There is now first considered a frame inversion method where all of the horizontal lines of a frame are driven with the same potential (either positive or negative) and that potential is reversed for successive frames.

Assuming that the liquid crystal display cells 22 on a particular respective vertical signal line 28 are driven to a random selection of transmittances, then, for the frame inversion method of driving the liquid crystal display (or at least where all of the liquid crystal display cells 22 of that vertical column are driven with the same potential), between using the signal line to drive the liquid crystal display cells 22 to which it is connected (in other words while other vertical columns are written), the signal line is preferably brought to a potential which on average will cause the least harm, in terms of leakage current, to all of the liquid crystal display cells 22 to which it is connected. Assuming that half of the liquid crystal display cells in a column are at zero volts and half of the liquid crystal display cells in that column are at maximum volts, then it is possible to calculate an appropriate mid-voltage Vmid as illustrated in FIG. 6 which, whilst not being midway between zero and maximum volts, has a similar effect with regard to leakage current on both saturated cell states. FIG. 7 illustrates the response of a liquid crystal cell which has zero transparency for zero applied volts together with an appropriate mid-voltage Vmid. The particular values of Vmid illustrated in FIGS. 6 and 7 provide 50% transparency.

In one embodiment, the signal line can be placed at a potential which is at a mid-point and which in general will cause the fully transmittant cells to reduce in transmittance by a given percentage (for instance 1 percent) at the same time as the non-transmittant cells reach that same percentage of transmittance. In this way, the overall time taken for the liquid crystal display to fade unacceptably will be maximised and the refresh rate can be reduced to a maximum.

Typically changes of 1 percent in the transmittance have been found to be an appropriate maximum for acceptable viewing by the user.

Having written an entire frame, the signal lines are preferably kept at the appropriate Vmid and Vcom is kept constant until the next frame. It will be appreciated that when a frame of pixels is driven with positive potentials relative to Vcom, Vmid is positive with respect to Vcom and when a frame of pixels is driven with negative potentials relative to Vcom, Vmid is negative with respect to Vcom.

For a 1H line inversion method as described above with reference to FIG. 5, each signal line 28 of course connects to a vertical array of liquid crystal display cells 22 whose potential is applied either positively or negatively relative to the COM line which moves up and down from one horizontal line to the next. Thus, while the liquid crystal display cell 22 of one horizontal line will have across it a potential of zero volts or a maximum positive volts (for instance +2.7 volts) relative to the COM line, the liquid crystal display cell 22 of the next horizontal line will have a potential of either zero volts or the negative maximum voltage (for instance −2.7 volts) relative to the COM line.

Therefore, for the 1H inversion method as described, it is best, on average, for the signal line to be at the potential of the COM line in between use of the signal line for writing the desired signal to the individual liquid crystal display cells 22.

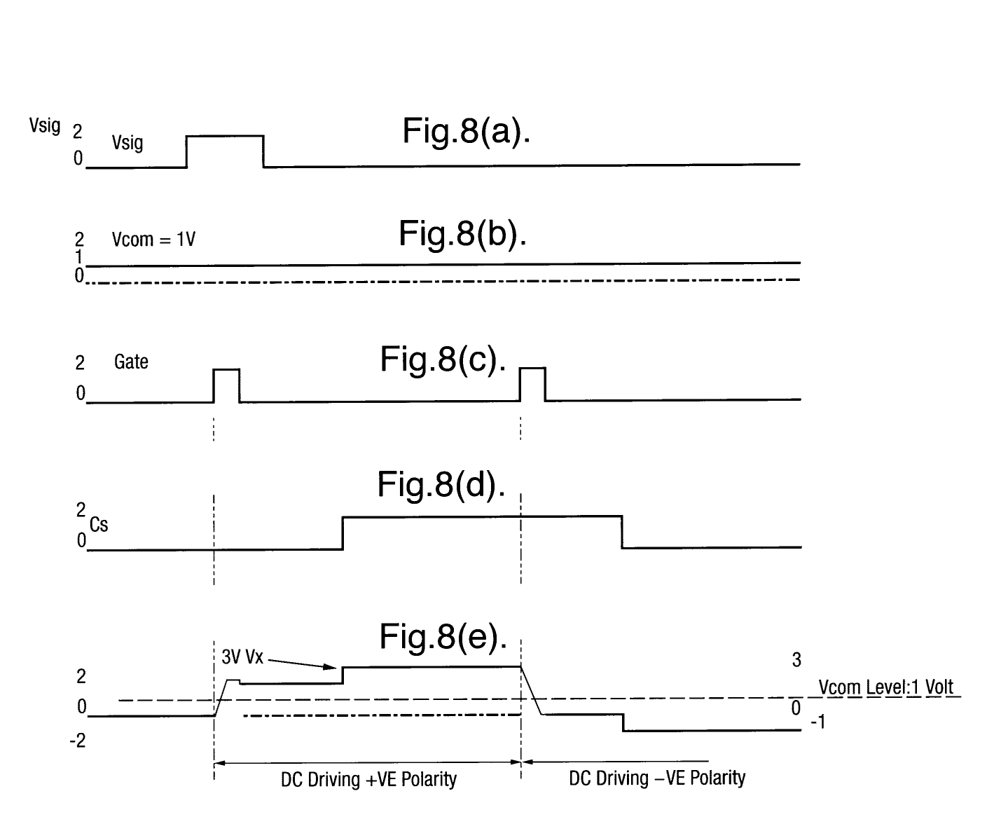

It is also known to use a driving method for liquid crystal displays in which Vcom is maintained as a DC level. Although this will be well understood by the skilled reader, a brief description is given with reference to FIG. 8.

As illustrated by trace (b), Vcom remains constant at, for instance, 1 volt.

A signal line is illustrated in trace (a) and a gate line illustrated in trace (c). While the signal line is at, for instance, 2 volts, the gate pulse connects that signal line to a particular liquid crystal display cell such that, as illustrated in trace (e), the voltage Vx on that cell (opposite to its Vcom side) rises to the signal level of 2 volts.

With the DC driving method, the CS voltage does not follow the Vcom voltage. As illustrated in trace (d), after the gate voltage has enabled the pixel transistor to apply the signal voltage to the liquid crystal cell, the CS voltage is changed from 0 volts to 2 volts. Depending upon the comparative capacitances of the CS capacitor and the liquid crystal cell, the voltage Vx on the liquid crystal cell will rise accordingly. In the illustrated example, there is a 50% coupling effect such that the voltage Vx on the liquid crystal cell rises to 3 volts.

In the next frame, in order to apply an opposite polarity to the liquid crystal cell, the gate enables the transistor to apply a signal voltage of 0 volts to Vx. However, when the CS voltage then returns to 0 volts, the coupling effect causes the voltage across the liquid crystal cell to drop further to −1 volts.

Thus, it will be appreciated that, from frame to frame, the voltage across the liquid crystal cell relative to Vcom (at +1 volt) will vary from +2 volts to −2 volts.

It will be appreciated that, in order to control each horizontal line separately, the CS line for respective horizontal lines is controlled separately.

For a 1H inversion driving method, once an entire frame has been written, there will be a mixture of positive polarity pixels at +1 volt and +3 volts, and negative polarity pixels at +1 volt a and −1 volt. Hence, until the next frame is to be written, it is proposed that the signal lines should be kept at the Vcom voltage, in this case +1 volt, in order to minimise leakage current.

For a 1F inversion method, at the end of writing one frame, for a positive polarity frame, the liquid crystal cells will be at a mixture of between 1 volt and 3 volts, whereas, for a negative polarity frame, the liquid crystal cells will be at a mixture of 1 volt and −1 volt.

Considered another way, for the positive polarity frame, relative to Vcom, the liquid crystal cells will be at a mixture of 0 volts and 2 volts. On the other hand, for a negative polarity frame, relative to Vcom, the liquid crystal cells will be at a mixture of 0 volts and −2 volts. Hence, for a positive polarity frame, it is proposed to set the signal line level to a mid-voltage as discussed above for the AC driving method, with that mid-voltage set above Vcom. On the other hand, for the negative polarity frame, the signal line level will be set to the mid-voltage level with a negative polarity relative to the Vcom voltage.

Of course, it is also possible for the driving circuit to take into account the actual image being displayed and the actual potentials being provided to the individual liquid crystal display cells 22 of a particular signal line 28. On the basis of the actual potentials provided on the liquid crystal display cells 22 of a particular signal line 28, the potential provided on that signal line 28 between writing to the individual liquid crystal display cells 22 could be controlled to its optimum value to minimise leakage current and allow maximum time between subsequent refreshed frames.

By means of the techniques outlined above, it is proposed that a normal mode refresh rate of 50-60 Hz could be reduced to 10 Hz or lower or 5 Hz or lower during the low-power mode. Indeed, it is proposed to provide a refresh rate of between 10 and 1 times per second for the low-power mode.

By virtue of the arrangement as discussed above, it is envisaged that typical power consumption of 3 mW could be reduced to less than 1 mW.

We claim:

1. A driving circuit for a liquid crystal display module having a frame formed of an array of liquid crystal cells and signal lines, each liquid crystal cell being chargeable via one of the signal lines by any amount between two saturated values so as to provide a corresponding display intensity, the driving circuit being configured:
to charge selectively all of the liquid crystal cells of the frame within a frame period so as to cause the array of liquid crystal cells to display an image;
during a first mode of operation, to recharge all of the liquid crystal cells repeatedly at a low refresh rate; and
during a second mode of operation, to recharge all of the liquid crystal cells repeatedly at a normal refresh rate, wherein said low refresh rate is lower than said normal refresh rate.

2. A driving circuit according to claim 1 wherein said normal refresh rate is between 50 and 60 times per second.

3. A driving circuit according to claim 1 wherein said low refresh rate is 10 times per second or lower.

4. A driving circuit according to claim 3 wherein said low refresh rate is 5 times per second or lower.

5. A driving circuit according to claim 4 wherein said low refresh rate is at least 1 time per second.

6. A driving circuit according to claim 1 further including a clock circuit configured to generate a sequence pulse, the driving circuit being responsive to the sequence pulse to recharge all of the liquid crystal cells.

7. A driving circuit according to claim 6 wherein the clock circuit is configured to generate the sequence pulse at the normal refresh rate.

8. A driving circuit according to claim 7 configured to, during the first mode of operation, ignore a predetermined plurality of consecutive sequence pulses so as to recharge all of the liquid crystal cells at the low refresh rate.

9. A driving circuit according to claim 7 wherein the clock circuit is configured to, during the first mode of operation, generate the sequence pulse at the low refresh rate.

10. A driving circuit according to claim 1 configured to, during the first mode of operation, charge all of the liquid crystal cells only to one or other of the two saturated values.

11. A driving circuit according to claim 1 configured to, during the first mode of operation, between charging respective liquid crystal cells, maintain on each signal line a voltage optimum to reduce charge leakage from the respective liquid crystal cells.

12. A driving circuit according to claim 11 configured to, during the first mode of operation, between charging respective liquid crystal cells, maintain on each signal line a voltage of zero volts, relative to the ground side of the liquid crystal cells.

13. A driving circuit according to claim 1 for use with a liquid crystal display module having a selectively operable back light for illuminating the liquid crystal cells, the driving circuit being configured to turn off the back light during the first mode of operation.

14. A driving circuit for a liquid crystal display module having a frame formed of an array of liquid crystal cells and signal lines, each liquid crystal cell being chargeable via one of the signal lines by any amount between two saturated values so as to provide a corresponding display intensity, the driving circuit being configured:
to charge selectively all of the liquid crystal cells of the frame within a frame period having a normal refresh rate so as to cause the array of liquid crystal cells to display an image;
during a first mode of operation, to cycle through at least one frame period before again charging selectively all of the liquid crystal cells of the array such that, during the first mode of operation, the driving circuit is configured to recharge all of the liquid crystal cells of the array repeatedly at a low refresh rate lower than said normal refresh rate for charging an individual frame of the array of liquid crystal cells.

15. A driving circuit according to claim 14 wherein said normal refresh rate is between 50 and 60 times per second.

16. A driving circuit according to claim 14 wherein said low refresh rate is 10 times per second or lower.

17. A driving circuit according to claim 16 wherein said low refresh rate is 5 times per second or lower.

18. A driving circuit according to claim 17 wherein said low refresh rate is at least 1 time per second.

19. A driving circuit according to claim 14 further including a clock circuit configured to generate a sequence pulse, the driving circuit being responsive to the sequence pulse to recharge all of the liquid crystal cells.

20. A driving circuit according to claim 19 wherein the clock circuit is configured to generate the sequence pulse at the normal refresh rate.

21. A driving circuit according to claim 19 configured to, during the first mode of operation, ignore a predetermined plurality of consecutive sequence pulses so as to recharge all of the liquid crystal cells at the low refresh rate.

22. A driving circuit according to claim 19 wherein the clock circuit is configured to, during the first mode of operation, generate the sequence pulse at the low refresh rate.

23. A driving circuit according to claim 14 configured to, during the first mode of operation, charge all of the liquid crystal cells only to one or other of the two saturated values.

24. A driving circuit according to claim 14 configured to, during the first mode of operation, between charging respective liquid crystal cells, maintain on each signal line a voltage optimum to reduce charge leakage from the respective liquid crystal cells.

25. A driving circuit according to claim 24 configured to, during the first mode of operation, between charging respective liquid crystal cells, maintain on each signal line a voltage of zero volts, relative to the ground side of the liquid crystal cells.

26. A driving circuit according to claim 14 for use with a liquid crystal display module having a selectively operable back light for illuminating the liquid crystal cells, the driving circuit being configured to turn off the back light during the first mode of operation.

27. A liquid crystal module including a liquid crystal display having a frame formed of an array of liquid crystal cells and signal lines, each liquid crystal cell being chargeable via one of the signal lines by any amount between two saturated values so as to provide a corresponding display intensity and including a driving circuit configured:
to charge selectively all of the liquid crystal cells of the frame within a frame period so as to cause the array of liquid crystal cells to display an image;
during a first mode of operation, to recharge all of the liquid crystal cells repeatedly at a low refresh rate; and
during a second mode of operation, to recharge all of the liquid crystal cells repeatedly at a normal refresh rate, wherein said low refresh rate is lower than said normal refresh rate.

28. A liquid crystal module including a liquid crystal display having a frame formed of an array of liquid crystal cells and signal lines, each liquid crystal cell being chargeable via one of the signal lines by any amount between two saturated values so as to provide a corresponding display intensity and including a driving circuit configured:
to charge selectively all of the liquid crystal cells of the frame within a frame period having a normal refresh rate so as to cause the array of liquid crystal cells to display an image;
during a first mode of operation, to cycle through at least one frame period before again charging selectively all of the liquid crystal cells of the array such that, during the first mode of operation, the driving circuit is configured to recharge all of the liquid crystal cells of the array repeatedly at a low refresh rate lower than said normal refresh rate for charging an individual frame of the array of liquid crystal cells.

29. A mobile telephone including a liquid crystal module according to claim 27.

30. A mobile telephone including a liquid crystal module according to claim 28.

31. A camera including a liquid crystal module according to claim 27.

32. A camera including a liquid crystal module according to claim 28.

33. A method of driving a liquid crystal display having a frame formed of an array of liquid crystal cells and signal lines, each liquid crystal cell being chargeable via one of the signal lines by any amount between two saturated values so as to provide a corresponding display intensity, the method including:
charging selectively all of the liquid crystal cells of the frame within a frame period so as to cause the array of liquid crystal cells to display an image;
during a first mode of operation, recharging all the liquid crystal cells repeatedly at a low refresh rate; and
during a second mode of operation, recharging all of the liquid crystal cells repeatedly at a normal refresh rate, wherein said low refresh rate is lower than said normal refresh rate.

34. A method of driving a liquid crystal display having a frame formed of an array of liquid crystal cells and signal lines, each liquid crystal cell being chargeable via one of the signal lines by any amount between two saturated values so as to provide a corresponding display intensity, the method including:
charging selectively all of the liquid crystal cells of the frame within a frame period having a normal refresh rate so as to cause the array of liquid crystal cells to display an image; and
during a first mode of operation, cycling through at least one frame period before again charging selectively all of the liquid crystal cells such that, during the first mode of operation, recharging successive frames occurs at a low refresh rate lower than said normal refresh rate for charging an individual frame of the array of liquid crystal cells.
